(19) United States
(12) Patent Application Publication
(10) Pub. No.: US 2025/0038192 A1
(43) Pub. Date: Jan. 30, 2025

(54) MANGANESE DIOXIDE POSITIVE ELECTRODE MATERIAL, POSITIVE ELECTRODE SHEET AND PREPARATION METHOD THEREFOR, AND ZINC ION BATTERY

(71) Applicant: MURATA MANUFACTURING CO., LTD., Kyoto (JP)

(72) Inventors: Li WANG, Shanghai (CN); Yuli LI, Shanghai (CN); Kazumasa TAKESHI, Shanghai (CN)

(21) Appl. No.: 18/777,088

(22) Filed: Jul. 18, 2024

(30) Foreign Application Priority Data
Jul. 28, 2023 (CN) 2023109440788

(51) Int. Cl. H01M 4/50; C01G 45/02; H01M 4/02; H01M 4/04; H01M 4/62; H01M 10/36

(52) U.S. Cl. CPC H01M 4/50; C01G 45/02; H01M 4/0404; H01M 4/622; H01M 4/625; H01M 10/36; C01P 2004/61; C01P 2004/62; C01P 2006/40; H01M 2004/028

(57) ABSTRACT

A manganese dioxide positive electrode material, a positive electrode sheet and a preparation method therefor, and a zinc ion battery are provided. The manganese dioxide positive electrode material for a zinc ion battery includes a mixed material of micron-sized manganese dioxide particles and nano-sized manganese dioxide particles, an aqueous binder, and a conductive agent; wherein the micron-sized manganese dioxide particles have an average particle size of about 1 μm to about 10 μm, and the nano-sized manganese dioxide particles have an average particle size of about 100 nm to about 500 nm.

### CROSS REFERENCE TO RELATED APPLICATIONS

This present application claims the benefit of Chinese Patent Application No. 2023109440788, filed on Jul. 28, 2023, and titled “Manganese dioxide positive electrode material, positive electrode sheet and preparation method therefor, and zinc ion battery”, the entire contents of which are incorporated by reference herein.

### BACKGROUND

The present disclosure generally relates to an aqueous zinc ion battery.

Rechargeable zinc ion batteries are rechargeable batteries using a manganese oxide material as a positive electrode active material, using zinc as a negative electrode active material, and using an aqueous solution containing zinc ions as an electrolyte. Such batteries are cheap.

Although zinc ion batteries have attracted the attention of researchers and developers in the energy field because of their high safety and low costs, positive electrode materials of zinc ion batteries mostly use nanomaterials, and thus NMP-based binders such as PVDF are required due to the high specific surface areas of the nanomaterials (see FIG. 1). The environmental load and costs of using NMP are high, and PVDF is currently in serious shortage for supply. Given the costs, environmental load, and resources of binders, a MnO₂ positive electrode with aqueous binder is a better choice compared to the MnO₂ positive electrode with binder PVDF.

However, less attention has been paid to the processability of MnO₂ positive electrodes, especially MnO₂ positive electrode with aqueous binder. A reason for such less attention, for example, is as follows: at present, nano-MnO₂ powder having a large specific surface area is mostly used to prepare a positive electrode slurry, and the slurry cannot be prepared using an aqueous binder, thus resulting in poor processability of preparing a MnO₂ positive electrode sheet using the aqueous binder.

### SUMMARY

The present disclosure generally relates to an aqueous zinc ion battery. More specifically, for example, the present disclosure relates to a manganese dioxide positive electrode material for a zinc ion battery, a method for preparing a manganese dioxide positive electrode sheet for a zinc ion battery, a manganese dioxide positive electrode sheet for a zinc ion battery, and a zinc ion battery. The present disclosure relates to providing, in an embodiment, a manganese dioxide positive electrode material for a zinc ion battery, a method for preparing a manganese dioxide positive electrode sheet for a zinc ion battery, a manganese dioxide positive electrode sheet for a zinc ion battery, and a zinc ion battery, so as to solve the technical problem in the prior art that the processability of preparing a MnO₂ positive electrode sheet using an aqueous binder is very poor.

According to an embodiment of the present disclosure, a manganese dioxide positive electrode material for a zinc ion battery is provided, wherein the manganese dioxide positive electrode material comprises: a mixed material of micron-sized manganese dioxide particles and nano-sized manganese dioxide particles, an aqueous binder, and a conductive agent; wherein the micron-sized manganese dioxide particles have an average particle size of about 1 μm to about 10 μm, and the nano-sized manganese dioxide particles have an average particle size of about 100 nm to about 500 nm.

Further, in the manganese dioxide positive electrode material for a zinc ion battery, in an embodiment, the weight ratio of the micron-sized manganese dioxide particles to the nano-sized manganese dioxide particles is 99:1 to 60:40, and preferably 90:10 to 60:40.

Further, in the manganese dioxide positive electrode material for a zinc ion battery, in an embodiment, the aqueous binder is selected from the group consisting of polyacrylonitriles, styrene butadiene rubbers, polyacrylic acids, and any combination thereof.

Further, in the manganese dioxide positive electrode material for a zinc ion battery, in an embodiment, the micron-sized manganese dioxide particles have an average particle size of about 1 μm to about 5 μm, and the nano-sized manganese dioxide particles have an average particle size of about 100 nm to about 200 nm.

Further, in the manganese dioxide positive electrode material for a zinc ion battery, in an embodiment, the weight ratio of the micron-sized manganese dioxide particles to the nano-sized manganese dioxide particles is 80:20 to 60:40.

According to another embodiment of the present disclosure, a method for preparing a manganese dioxide positive electrode sheet for a zinc ion battery is provided. The method comprises the following steps: step S1: mixing micron-sized manganese dioxide particles, nano-sized manganese dioxide particles, an aqueous binder, and a conductive agent to form a manganese dioxide positive electrode material; step S2: adding water to the manganese dioxide positive electrode material to form a manganese dioxide positive electrode slurry; and step S3: coating the manganese dioxide positive electrode slurry on a current collector to form a manganese dioxide positive electrode sheet; wherein the micron-sized manganese dioxide particles have an average particle size of about 1 μm to about 10 μm, and the nano-sized manganese dioxide particles have an average particle size of about 100 nm to about 500 nm.

Further, in the method, in an embodiment, the weight ratio of the micron-sized manganese dioxide particles to the nano-sized manganese dioxide particles is 99:1 to 60:40, and preferably 90:10 to 60:40.

Further, in the method, in an embodiment, the aqueous binder is selected from the group consisting of polyacrylonitriles, styrene butadiene rubbers, polyacrylic acids, and any combination thereof.

Further, in the method, in an embodiment, the micron-sized manganese dioxide particles have an average particle size of about 1 μm to about 5 μm, and the nano-sized manganese dioxide particles have an average particle size of about 100 nm to about 200 nm.

Further, in the method, in an embodiment, the weight ratio of the micron-sized manganese dioxide particles to the nano-sized manganese dioxide particles is 80:20 to 60:40.

According to yet another embodiment of the present disclosure, a manganese dioxide positive electrode sheet for a zinc ion battery is provided. The manganese dioxide positive electrode sheet comprises the manganese dioxide positive electrode material or is prepared by the method.

According to still another embodiment of the present disclosure, a zinc ion battery is provided, comprising: a positive electrode sheet, a negative electrode sheet, and a separator, wherein the positive electrode sheet comprises the manganese dioxide positive electrode material or is prepared by the method.

In the manganese dioxide positive electrode material for a zinc ion battery, in an embodiment, the method for preparing a manganese dioxide positive electrode sheet for a zinc ion battery, the manganese dioxide positive electrode sheet for a zinc ion battery, and the zinc ion battery according to the preset disclosure, by using the mixture of micron-sized manganese dioxide particles and nano-sized manganese dioxide particles having the specific range of average particle size, the processability and electrochemical properties of a MnO₂ positive electrode with aqueous binder are improved, and further, the costs and environmental load of the positive electrode are reduced.

### BRIEF DESCRIPTION OF THE FIGURES

FIG. 1 shows a MnO₂ positive electrode sheet prepared by using a PVDF binder, and the processability thereof is poor.

FIG. 2 shows a positive electrode sheet prepared in Example 1 of the present application, wherein a slurry is prepared successfully, a film is easily formed by stretching, and the processability is good.

FIG. 3 shows a slurry prepared in Comparative Example 3, wherein the slurry is not successfully prepared, a film could not be formed by stretching, and the processability is poor.

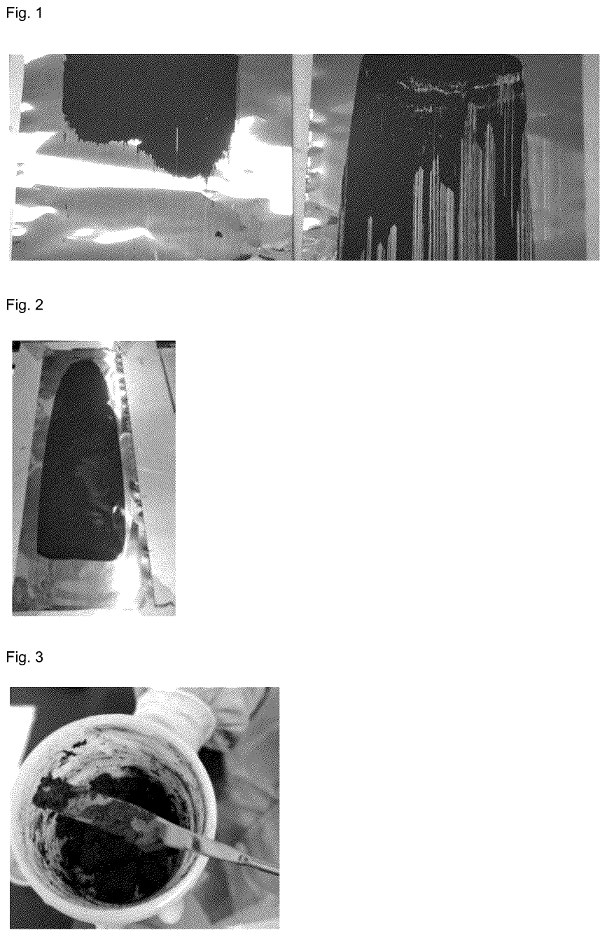

### DETAILED DESCRIPTION

It is to be noted that embodiments in the present disclosure and features in the embodiments can be combined with one another in any suitable manner according to an embodiment. Hereinafter, the present disclosure is described in further detail according to one or more embodiments. The following embodiments are merely exemplary, and the present disclosure is not limited thereto.

As stated in the Background section, a nano-MnO₂ powder is generally used to prepare a positive electrode slurry. However, due to the large specific surface area of the nano-MnO₂ powder, the slurry cannot be prepared by using an aqueous binder, thus resulting in poor processability of preparing the MnO₂ positive electrode sheet by using the aqueous binder. Therefore, there is still a need for further improvement. According to an embodiment of the present application, a manganese dioxide positive electrode material for a zinc ion battery is provided. The manganese dioxide positive electrode material comprises: a mixed material of micron-sized manganese dioxide particles and nano-sized manganese dioxide particles, an aqueous binder, and a conductive agent; wherein the micron-sized manganese dioxide particles have an average particle size of about 1 μm-about 10 μm, and the nano-sized manganese dioxide particles have an average particle size of about 100 nm-about 500 nm.

In the manganese dioxide positive electrode material for a zinc ion battery of the present application, in an embodiment, preparing a positive electrode slurry by using, as an active positive electrode material, a combination of micron-sized manganese dioxide particles having an average particle size of about 1 μm-about 10 μm and nano-sized manganese dioxide particles having an average particle size of about 100 nm-about 500 nm can reduce the specific surface area of the manganese dioxide particles, so that a positive electrode slurry can be prepared by using an aqueous binder, and thus the processability and electrochemical properties of the MnO₂ positive electrode with aqueous binder are improved, and the costs and environmental load of the positive electrode are further reduced.

For one or more one or more embodiments, the micron-sized manganese dioxide particles can have an average particle size of about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm. Specifically, the micron-sized manganese dioxide particles can have an average particle size of about 1 μm-about 10 μm, about 1 μm-about 9.5 μm, about 1 μm-about 9 μm, about 1 μm-about 8.5 μm, about 1 μm-about 8 μm, about 1 μm-about 7.5 μm, about 1 μm-about 7 μm, about 1 μm-about 6.5 μm, about 1 μm-about 6 μm, about 1 μm-about 5.5 μm, about 1 μm-about 4.5 μm, about 1 μm-about 4 μm, about 1.5 μm-about 10 μm, about 1.5 μm-about 9.5 μm, about 1.5 μm-about 9 μm, about 1.5 μm-about 8.5 μm, about 1.5 μm-about 8 μm, about 1.5 μm-about 7.5 μm, about 1.5 μm-about 7 μm, about 1.5 μm-about 6.5 μm, about 1.5 μm-about 6 μm, about 1.5 μm-about 5.5 μm, about 1.5 μm-about 4.5 μm, about 1.5 μm-about 4 μm, about 2 μm-about 10 μm, about 2 μm-about 9.5 μm, about 2 μm-about 9 μm, about 2 μm-about 8.5 μm, about 2 μm-about 8 μm, about 2 μm-about 7.5 μm, about 2 μm-about 7 μm, about 2 μm-about 6.5 μm, about 2 μm-about 6 μm, about 2 μm-about 5.5 μm, about 2 μm-about 4.5 μm, about 2 μm-about 4 μm, about 3 μm-about 10 μm, about 3 μm-about 9.5 μm, about 3 μm-about 9 μm, about 3 μm-about 8.5 μm, about 3 μm-about 8 μm, about 3 μm-about 7.5 μm, about 3 μm-about 7 μm, about 3 μm-about 6.5 μm, about 3 μm-about 6 μm, about 3 μm-about 5.5 μm, about 3 μm-about 4.5 μm, or about 3 μm-about 4 μm.

Similarly, for one or more embodiments, the nano-sized manganese dioxide particles can have an average particle size of about 100 nm, about 150 nm, about 200 nm, about 250 nm, about 300 nm, about 350 nm, about 400 nm, about 450 nm, or about 500 nm. In particular, the nano-sized manganese dioxide particles can have an average particle size of about 100-about 500 nm, about 100-about 450 nm, about 100-about 400 nm, about 100-about 350 nm, about 100-about 300 nm, about 100-about 250 nm, about 100-about 200 nm, about 150-about 500 nm, about 150-about 450 nm, about 150-about 400 nm, about 150-about 350 nm, about 150-about 300 nm, about 150-about 250 nm, about 200-about 500 nm, about 200-about 450 nm, about 200-about 400 nm, about 200-about 350 nm, or about 200-about 300 nm.

Preferably, in the manganese dioxide positive electrode material for a zinc ion battery, in an embodiment, the micron-sized manganese dioxide particles can have an average particle size of about 1 μm-about 5 μm, and the nano-sized manganese dioxide particles can have an average particle size of about 100 nm-about 200 nm.

In one or more embodiments of the present application, in the manganese dioxide positive electrode material for a zinc ion battery, the weight ratio of the micron-sized manganese dioxide particles to the nano-sized manganese dioxide particles is 99:1-60:40, and preferably 90:10-60:40. When the weight ratio of the micron-sized manganese dioxide particles to the nano-sized manganese dioxide particles is within this range, the processability and electrochemical properties of the MnO₂ positive electrode with aqueous binder can be significantly improved.

In particular, for one or more embodiments, the weight ratio of the micron-sized manganese dioxide particles to the nano-sized manganese dioxide particles can be 99:1, 95:5, 90:10, 85:15, 80:20, 75:25, 70:30, 65:35, or 60:40. In particular, the weight ratio of the micron-sized manganese dioxide particles to the nano-sized manganese dioxide particles can be 99:1-60:40, 99:1-65:35, 99:1-70:30, 99:1-75:25, 99:1-80:20, 95:5-60:40, 95:5-65:35, 95:5-70:30, 95:5-75:25, 95:5-80:20, 90:10-60:40, 90:10-65:35, 90:10-70:30, 90:10-75:25, 90:10-80:20, 85:15-60:40, 85:15-65:35, 85:15-70:30, 85:15-75:25, 80:20-60:40, 80:20-65:35, 80:20-70:30, or 80:20-75:25.

Preferably, in the manganese dioxide positive electrode material for a zinc ion battery, in an embodiment, the weight ratio of the micron-sized manganese dioxide particles to the nano-sized manganese dioxide particles is 80:20-60:40. When the weight ratio of the micron-sized manganese dioxide particles to the nano-sized manganese dioxide particles is within this range, the processability and electrochemical properties of the MnO₂ positive electrode with aqueous binder can be more significantly improved.

In one or more embodiments of the present application, in the manganese dioxide positive electrode material for a zinc ion battery, the conductive agent can be one or a combination of more of carbon black, VGCF, CNTs, graphene, and the like. The above-mentioned conductive agents are only given as examples, and are not intended to be limiting, and a person skilled in the art would have been able to choose a specific conductive agent according to needs.

In one or more embodiments of the present application, in the manganese dioxide positive electrode material for a zinc ion battery, the aqueous binder is selected from the group consisting of polyacrylonitriles, styrene butadiene rubbers, polyacrylic acids, and any combination thereof. The described aqueous binders are only given as examples, and are not intended to be limiting. A person skilled in the art would have been able to choose a specific aqueous binder according to needs. In the present application, the costs and environmental load of the positive electrode are reduced by using the aqueous binder.

According to another embodiment of the present disclosure, a method for preparing a manganese dioxide positive electrode sheet for a zinc ion battery is provided. The method comprises the following steps: step S1: mixing micron-sized manganese dioxide particles, nano-sized manganese dioxide particles, an aqueous binder, and a conductive agent to form a manganese dioxide positive electrode material; step S2: adding water to a manganese dioxide positive electrode material to form a manganese dioxide positive electrode slurry; and step S3: coating the manganese dioxide positive electrode slurry on a current collector to form a manganese dioxide positive electrode sheet; wherein the micron-sized manganese dioxide particles have an average particle size of about 1 μm-about 10 μm, and the nano-sized manganese dioxide particles have an average particle size of about 100 nm-about 500 nm.

In the method for preparing a manganese dioxide positive electrode sheet for a zinc ion battery of the present application, in an embodiment, preparing a positive electrode sheet by using, as an active positive electrode material, a combination of micron-sized manganese dioxide particles having an average particle size of about 1 μm-about 10 μm and nano-sized manganese dioxide particles having an average particle size of about 100 nm-about 500 nm can reduce the specific surface area of the manganese dioxide particles, so that a positive electrode slurry can be prepared by using an aqueous binder, and thus the processability and electrochemical properties of the MnO₂ positive electrode sheet with aqueous binder are improved, and the costs and environmental load of the positive electrode are further reduced.

For one or more embodiments, the micron-sized manganese dioxide particles can have an average particle size of about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm. Specifically, the micron-sized manganese dioxide particles can have an average particle size of about 1 μm-about 10 μm, about 1 μm-about 9.5 μm, about 1 μm-about 9 μm, about 1 μm-about 8.5 μm, about 1 μm-about 8 μm, about 1 μm-about 7.5 μm, about 1 μm-about 7 μm, about 1 μm-about 6.5 μm, about 1 μm-about 6 μm, about 1 μm-about 5.5 μm, about 1 μm-about 4.5 μm, about 1 μm-about 4 μm, about 1.5 μm-about 10 μm, about 1.5 μm-about 9.5 μm, about 1.5 μm-about 9 μm, about 1.5 μm-about 8.5 μm, about 1.5 μm-about 8 μm, about 1.5 μm-about 7.5 μm, about 1.5 μm-about 7 μm, about 1.5 μm-about 6.5 μm, about 1.5 μm-about 6 μm, about 1.5 μm-about 5.5 μm, about 1.5 μm-about 4.5 μm, about 1.5 μm-about 4 μm, about 2 μm-about 10 μm, about 2 μm-about 9.5 μm, about 2 μm-about 9 μm, about 2 μm-about 8.5 μm, about 2 μm-about 8 μm, about 2 μm-about 7.5 μm, about 2 μm-about 7 μm, about 2 μm-about 6.5 μm, about 2 μm-about 6 μm, about 2 μm-about 5.5 μm, about 2 μm-about 4.5 μm, about 2 μm-about 4 μm, about 3 μm-about 10 μm, about 3 μm-about 9.5 μm, about 3 μm-about 9 μm, about 3 μm-about 8.5 μm, about 3 μm-about 8 μm, about 3 μm-about 7.5 μm, about 3 μm-about 7 μm, about 3 μm-about 6.5 μm, about 3 μm-about 6 μm, about 3 μm-about 5.5 μm, about 3 μm-about 4.5 μm, or about 3 μm-about 4 μm.

Similarly, for one or more embodiments, the nano-sized manganese dioxide particles can have an average particle size of about 100 nm, about 150 nm, about 200 nm, about 250 nm, about 300 nm, about 350 nm, about 400 nm, about 450 nm, or about 500 nm. In particular, the nano-sized manganese dioxide particles can have an average particle size of about 100-about 500 nm, about 100-about 450 nm, about 100-about 400 nm, about 100-about 350 nm, about 100-about 300 nm, about 100-about 250 nm, about 100-about 200 nm, about 150-about 500 nm, about 150-about 450 nm, about 150-about 400 nm, about 150-about 350 nm, about 150-about 300 nm, about 150-about 250 nm, about 200-about 500 nm, about 200-about 450 nm, about 200-about 400 nm, about 200-about 350 nm, or about 200-about 300 nm.

Preferably, in the manganese dioxide positive electrode material for a zinc ion battery, in an embodiment, the micron-sized manganese dioxide particles can have an average particle size of about 1 μm-about 5 μm, and the nano-sized manganese dioxide particles can have an average particle size of about 100 nm-about 200 nm.

In one or more embodiments of the present application, in the method for preparing a manganese dioxide positive electrode sheet for a zinc ion battery, the weight ratio of the micron-sized manganese dioxide particles to the nano-sized manganese dioxide particles is 99:1-60:40, and preferably 90:10-60:40. When the weight ratio of the micron-sized manganese dioxide particles to the nano-sized manganese dioxide particles is within this range, the processability and electrochemical properties of a MnO₂ positive electrode sheet with aqueous binder can be significantly improved.

In particular, for one or more embodiments, the weight ratio of the micron-sized manganese dioxide particles to the nano-sized manganese dioxide particles can be 99:1, 95:5, 90:10, 85:15, 80:20, 75:25, 70:30, 65:35, or 60:40. In particular, the weight ratio of the micron-sized manganese dioxide particles to the nano-sized manganese dioxide particles can be 99:1-60:40, 99:1-65:35, 99:1-70:30, 99:1-75:25, 99:1-80:20, 95:5-60:40, 95:5-65:35, 95:5-70:30, 95:5-75:25, 95:5-80:20, 90:10-60:40, 90:10-65:35, 90:10-70:30, 90:10-75:25, 90:10-80:20, 85:15-60:40, 85:15-65:35, 85:15-70:30, 85:15-75:25, 80:20-60:40, 80:20-65:35, 80:20-70:30, or 80:20-75:25.

Preferably, in the method for preparing a manganese dioxide positive electrode sheet for a zinc ion battery, in an embodiment, the weight ratio of the micron-sized manganese dioxide particles to the nano-sized manganese dioxide particles is 80:20-60:40. When the weight ratio of the micron-sized manganese dioxide particles to the nano-sized manganese dioxide particles is within this range, the processability and electrochemical properties of the MnO₂ positive electrode sheet with aqueous binder can be more significantly improved.

In one or more embodiments of the present application, in the method for preparing a manganese dioxide positive electrode sheet for a zinc ion battery, the conductive agent can be one or a combination of more of carbon black, VGCF, CNTs, graphene, and the like. The above-mentioned conductive agents are only given as examples, and are not intended to be limiting, and a person skilled in the art would have been able to choose a specific conductive agent according to needs.

In one or more embodiments of the present application, in the method for preparing a manganese dioxide positive electrode sheet for a zinc ion battery, the aqueous binder is selected from the group consisting of polyacrylonitriles, styrene butadiene rubbers, polyacrylic acids, and any combination thereof. The described aqueous binders are only given as examples, and are not intended to be limiting. A person skilled in the art would have been able to choose a specific aqueous binder according to needs. In the present application, the costs and environmental load of the positive electrode are reduced by using the aqueous binder.

In one or more embodiments of the present application, in the method for preparing a manganese dioxide positive electrode sheet for a zinc ion battery, in step S2, water can be deionized water, but is not limited thereto.

In one or more embodiments of the present application, in the method for preparing a manganese dioxide positive electrode sheet for a zinc ion battery, in step S3, the current collector includes, but is not limited to, stainless steel foil, titanium foil, stainless steel mesh, titanium mesh, carbon-coated stainless steel foil, carbon-coated titanium foil, carbon paper, carbon cloth, and the like.

According to another embodiment of the present disclosure, a manganese dioxide positive electrode sheet for a zinc ion battery is provided. The manganese dioxide positive electrode sheet comprises the manganese dioxide positive electrode material of the present disclosure or is prepared by the method of the present disclosure. By comprising the manganese dioxide positive electrode material of the present disclosure or preparing the manganese dioxide positive electrode sheet by the method of the present disclosure, the manganese dioxide positive electrode sheet for a zinc ion battery can be easily prepared, the electrochemical properties can be improved, and the preparation costs and environmental load of the positive electrode are further reduced.

According to another embodiment of the present disclosure, a zinc ion battery is provided, comprising: a positive electrode sheet, a negative electrode sheet, and a separator, the positive electrode sheet comprises the manganese dioxide positive electrode material of the present disclosure or is prepared by the method of the present disclosure. As the positive electrode sheet comprises the manganese dioxide positive electrode material of the present disclosure or is prepared by the method of the present disclosure, the zinc ion battery can be easily prepared, the electrochemical properties are improved, and the preparation costs and the environmental load are both reduced.

### EXAMPLE

The present disclosure will be described in further detail in conjunction with the following examples according to an embodiment, and the present disclosure is not limited thereto.

### Preparation of Battery

### Example 1 (the Weight Ratio of Micron-Sized Manganese Dioxide to Nano-Sized Manganese Dioxide was 90:10)

6.3 g of micron-sized manganese dioxide (D50=5 μm) particles and 0.7 g of nano-sized manganese dioxide (D50=200 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Example 2 (the Weight Ratio of Micron-Sized Manganese Dioxide to Nano-Sized Manganese Dioxide was 80:20)

5.6 g of micron-sized manganese dioxide (D50=5 μm) particles and 1.4 g of nano-sized manganese dioxide (D50=200 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Example 3 (the Weight Ratio of Micron-Sized Manganese Dioxide to Nano-Sized Manganese Dioxide was 60:40)

4.2 g of micron-sized manganese dioxide (D50=5 μm) particles and 2.8 g of nano-sized manganese dioxide (D50=200 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Comparative Example 1 (Containing Only Micron-Sized Manganese Dioxide)

7 g of micron-sized manganese dioxide (D50=5 μm) particles were taken, the manganese dioxide particles were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Comparative Example 2 (the Weight Ratio of Micron-Sized Manganese Dioxide to Nano-Sized Manganese Dioxide is 50:50)

3.5 g of micron-sized manganese dioxide (D50=5 μm) particles and 3.5 g of nano-sized manganese dioxide (D50=200 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, but the prepared slurry was unstable and quick to dry, and was not easily stretched to form a film.

### Comparative Example 3 (Containing Only Nano-Sized Manganese Dioxide)

7 g of nano-sized manganese dioxide (D50=200 nm) particles were taken, the manganese dioxide particles were mixed with LA132 binder and Super P carbon black conductive agent in a weight ratio of 7:1:2, and deionized water was added to prepare a slurry with a solid content of 40.0 wt. %. However, as shown in FIG. 3, the slurry was not successfully prepared, and a film could not be formed by stretching.

### Example 4 (the Weight Ratio of Micron-Sized Manganese Dioxide to Nano-Sized Manganese Dioxide was 90:10)

6.3 g of micron-sized manganese dioxide (D50=1 μm) particles and 0.7 g of nano-sized manganese dioxide (D50=100 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Example 5 (the Weight Ratio of Micron-Sized Manganese Dioxide to Nano-Sized Manganese Dioxide was 80:20)

5.6 g of micron-sized manganese dioxide (D50=1 μm) particles and 1.4 g of nano-sized manganese dioxide (D50=100 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Example 6 (the Weight Ratio of Micron-Sized Manganese Dioxide to Nano-Sized Manganese Dioxide was 60:40)

4.2 g of micron-sized manganese dioxide (D50=1 μm) particles and 2.8 g of nano-sized manganese dioxide (D50=100 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Comparative Example 4 (Containing Only Micron-Sized Manganese Dioxide)

7 g of micron-sized manganese dioxide (D50=1 μm) particles were taken, and the manganese dioxide particles were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Comparative Example 5 (the Weight Ratio of Micron-Sized Manganese Dioxide to Nano-Sized Manganese Dioxide was 50:50)

3.5 g of micron-sized manganese dioxide (D50=1 μm) particles and 3.5 g of nano-sized manganese dioxide (D50=100 nm) particles were taken, the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. However, a slurry was not successfully prepared, and could not be stretched to form a film.

### Comparative Example 6 (Containing Only Nano-Sized Manganese Dioxide)

7 g of nano-sized manganese dioxide (D50=100 μm) particles were taken, the manganese dioxide particles were mixed with LA132 binder and Super P carbon black conductive agent in a weight ratio of 7:1:2, and deionized water was added to prepare a slurry with a solid content of 40.0 wt. %. However, a slurry was not successfully prepared, and could not be stretched to form a film.

### Example 7 (the Weight Ratio of Micron-Sized Manganese Dioxide to Nano-Sized Manganese Dioxide was 90:10)

6.3 g of micron-sized manganese dioxide (D50=10 μm) particles and 0.7 g of nano-sized manganese dioxide (D50=500 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Example 8 (the Weight Ratio of Micron-Sized Manganese Dioxide to Nano-Sized Manganese Dioxide was 80:20)

5.6 g of micron-sized manganese dioxide (D50=10 μm) particles and 1.4 g of nano-sized manganese dioxide (D50=500 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Example 9 (Weight Ratio of Micron-Sized Manganese Dioxide to Nano-Sized Manganese Dioxide was 60:40)

4.2 g of micron-sized manganese dioxide (D50=10 μm) particles and 2.8 g of nano-sized manganese dioxide (D50=500 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Comparative Example 7 (Containing Only Micron-Sized Manganese Dioxide)

7 g of micron-sized manganese dioxide (D50=10 μm) particles were taken, and the manganese dioxide particles were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Comparative Example 8 (the Weight Ratio of Micron-Sized Manganese Dioxide to Nano-Sized Manganese Dioxide was 50:50)

3.5 g of micron-sized manganese dioxide (D50=10 μm) particles and 3.5 g of nano-sized manganese dioxide (D50=500 nm) particles were taken, and the manganese dioxide particles (micron-sized manganese dioxide+nano-sized manganese dioxide) were mixed with LA132 binder and Super P carbon black conductive agent in a weight ratio of 7:1:2, and deionized water was added to prepare a slurry with a solid content of 40.0 wt. %. The slurry was coated on the surface of a 20 μm thick stainless steel foil, and dried at 60° C. for 20 min to prepare a positive electrode sheet. A CR2032 button cell was assembled from the positive electrode sheet, a 150 μm thick zinc sheet (negative electrode sheet), a glass fiber separator, and 150 μL of an aqueous electrolyte solution (an aqueous zinc sulfate solution, having a concentration of 2 M).

### Comparative Example 9 (Containing Only Nano-Sized Manganese Dioxide)

7 g of nano-sized manganese dioxide (D50=500 nm) particles were taken, the manganese dioxide particles were mixed with LA132 binder and Super P carbon black conductive agent in a weight ratio of 7:1:2, and deionized water was added to prepare a slurry with a solid content of 40.0 wt. %. However, a slurry was not successfully prepared and could not be stretched to form a film.

### Testing of Battery Properties

### 1. Determination of Capacity Retention Rate

A charge and discharge instrument was used to test the discharge capacity and cycle performance of a battery.

First, charging was performed under conditions of an ambient temperature of 23° C., a charging voltage of 1.8 V, and a charging current of 100 mA/g, then discharging was performed under conditions of a discharging current of 100 mA/g and a termination voltage of 0.8 V, and the first discharge capacity (discharge capacity at the first cycle) was measured. Subsequently, repeat charging and discharging were performed under conditions of an ambient temperature of 23° C., a charging voltage of 1.8 V, a charging current of 100 mA/g, a discharging current of 50 mA/g and a termination voltage of 0.8 V. Subsequently, the discharge capacity at the 50th cycle was measured. Subsequently, the capacity retention rate (%) after 50 cycles was calculated based on the following equation using the discharge capacity at the first cycle and the discharge capacity at the 50th cycle.

$$Capacity retention rate after 50 cycles [ \% ] = ( discharge capacity after the 50 th cycle / first discharge capacity ( first cycle ) ) \times 100 \%$$

### 2. Determination of Peel Strength

Sample preparation: A double-sided tape (with a width of 2 cm) of a certain length (at least 15 cm) was cut with scissors and adhered to a positive electrode sheet, the surface of the tape was flattened with a roller, then samples were cut with the cutters closely along the edge of the tape, the white part of the double-sided tape was peeled off, the double-sided tape was used to adhere an electrode sheet to a steel plate cleaned with alcohol, the current collector faced upwards, and then the current collector was rolled by means of a roller for 10 cycles.

Tests: The current collector and the electrode sheet with half the length of the sample were separated from each other, and a steel plate and the separated current collector were clamped at 180 degrees onto a universal testing machine. The separated current collector was clamped to an upper clamp, and the steel plate was clamped to a lower clamp. The upper clamp of the universal testing machine was loaded with a certain force and slowly moved upward to an end point, so that the other half of non-separated current collector and the electrode sheet were also peeled apart. By means of the measured force enabling the other half of current collector and electrode sheet to be peeled apart and the width of the electrode sheet sample, the peeling strength was automatically calculated by the universal testing machine:

$$Peeing strength ( mN / mm ) = peeling force ( mM ) / sample width ( mm )$$

Table 1 shows evaluation results of the zinc ion batteries prepared according to Comparative Examples 1-3 and Examples 1-3.

TABLE 1

| | | First | Capacity | |
|---|---|---|---|---|
| | | discharge | retention | Peeling |
| | | capacity | after 50 | strength |
| Example | Processability | (mAh/g) | cycles [%] | (mN/mm) |
| Example 1 | A slurry was prepared | 206 | 100.7 | 52.1 |
| MnO₂ (D50: | successfully, could be | | | |
| 5 μm)/MnO₂ | easily stretched to | | | |
| (D50: | form a film, and has | | | |
| 200 nm) = | good processability | | | |
| 90:10 | | | | |
| Example 2 | A slurry was prepared | 214 | 100.7 | 51.2 |
| MnO₂ (D50: | successfully, could be | | | |
| 5 μm)/MnO₂ | easily stretched to | | | |
| (D50: | form a film, and has | | | |
| 200 nm) = | good processability | | | |
| 80:20 | | | | |
| Example 3 | A slurry was prepared | 226 | 100.6 | 40.8 |
| MnO₂ (D50: | successfully, could be | | | |
| 5 μm)/MnO₂ | easily stretched to | | | |
| (D50: | form a film, and has | | | |
| 200 nm) = | good processability | | | |
| 60:40 | | | | |
| Comparative | A slurry was prepared | 178 | 99.9 | 52.6 |
| Example 1 | successfully, could be | | | |
| 100% MnO₂ | easily stretched to | | | |
| (D50: 5 μm) | form a film, and has | | | |
| | good processability | | | |
| Comparative | The prepared slurry | failure | failure | 25.8 |
| Example 2 | was unstable and | to test | to test | |
| MnO₂ (D50: | quick to dry, could | | | |
| 5 μm)/MnO₂ | not be easily | | | |
| (D50: | stretched to form a | | | |
| 200 nm) = | film, and has poor | | | |
| 50:50 | processability | | | |
| Comparative | Slurry preparation | failure | failure | failure |
| Example 3 | was unsuccessful, | to test | to test | to test |
| 100% MnO₂ | and the slurry could | | | |
| (D50: 200 nm) | not be stretched to | | | |
| | form a film and has | | | |
| | poor processability | | | |

Table 2 shows the evaluation results of the zinc ion batteries prepared according to Comparative Examples 4-6 and Examples 4-6.

TABLE 2

| | | First | Capacity | |
|---|---|---|---|---|
| | | discharge | retention | Peeling |
| | | capacity | after 50 | Strength |
| Example | Processability | (mAh/g) | cycles [%] | (mN/mm) |
| Example 4 | A slurry was prepared | 218 | 100.3 | 48.0 |
| MnO₂ (D50: | successfully, could be | | | |
| 1 μm)/MnO₂ | easily stretched to | | | |
| (average | form a film, and has | | | |
| particle size: | good processability | | | |
| 100 nm) = | | | | |
| 90:10 | | | | |
| Example 5 | A slurry was prepared | 233 | 100.2 | 46.5 |
| MnO₂ (D50: | successfully, could be | | | |
| 1 μm)/MnO₂ | easily stretched to | | | |
| (average | form a film, and has | | | |
| particle size: | good processability | | | |
| 100 nm) = | | | | |
| 80:20 | | | | |
| Example 6 | A slurry was prepared | 248 | 100.2 | 44.6 |
| MnO₂ (D50: | successfully, could be | | | |
| 1 μm)/MnO₂ | easily stretched to | | | |
| (D50: | form a film, and has | | | |
| 100 nm) = | good processability | | | |
| 60:40 | | | | |
| Comparative | A slurry was prepared | 195 | 99.8 | 48.1 |
| Example 4 | successfully, could be | | | |
| 100% micron- | easily stretched to | | | |
| sized MnO₂ | form a film, and has | | | |
| (D50: 1 μm) | good processability | | | |
| Comparative | Slurry preparation | failure | failure | failure |
| Example 5 | was unsuccessful, | to test | to test | to test |
| MnO₂ | and the slurry could | | | |
| (D50: 1 μm)/ | not be stretched to | | | |
| MnO₂ (D50: | form a film and has | | | |
| 100 nm) = | poor processability | | | |
| 50:50 | | | | |
| Comparative | Slurry preparation | failure | failure | failure |
| Example 6 | was unsuccessful, | to test | to test | to test |
| 100% nano- | and the slurry could | | | |
| sized MnO₂ | not be stretched to | | | |
| (D50: 100 nm) | form a film and has | | | |
| | poor processability | | | |

Table 3 shows the evaluation results of the zinc ion batteries prepared according to Comparative Examples 7-9 and Examples 7-9.

TABLE 3

| | | First | Capacity | |
|---|---|---|---|---|
| | | discharge | retention | Peeling |
| | | capacity | after 50 | Strength |
| Example | Processability | (mAh/g) | cycles [%] | (mN/mm) |
| Example 7 | A slurry was prepared | 180 | 100.6 | 56.0 |
| MnO₂ (D50: | successfully, could be | | | |
| 10 μm)/MnO₂ | easily stretched to | | | |
| (average | form a film, and has | | | |
| particle size: | good processability | | | |
| 500 nm) = | | | | |
| 90:10 | | | | |
| Example 8 | A slurry was prepared | 195 | 100.4 | 55.8 |
| MnO₂ (D50: | successfully, could be | | | |
| 10 μm)/MnO₂ | easily stretched to | | | |
| (average | form a film, and has | | | |
| particle size: | good processability | | | |
| 500 nm) = | | | | |
| 80:20 | | | | |
| Example 9 | A slurry was prepared | 212 | 100.3 | 49.6 |
| MnO₂ (D50: | successfully, could be | | | |
| 10 μm)/MnO₂ | easily stretched to | | | |
| (average | form a film, and has | | | |
| particle size: | good processability | | | |
| 500 nm) = | | | | |
| 60:40 | | | | |
| Comparative | A slurry was prepared | 165 | 100.1 | 56.4 |
| Example 7 | successfully, could be | | | |
| 100% micron- | easily stretched to | | | |
| sized MnO₂ | form a film, and has | | | |
| (D50: 10 μm) | good processability | | | |
| Comparative | A slurry was barely | 160 | 99.5 | 21.1 |
| Example 8 | prepared successfully, | | | |
| MnO₂ (D50: | could not be easily | | | |
| 10 μm)/MnO₂ | stretched to form a | | | |
| (average | film, and has poor | | | |
| particle size: | processability | | | |
| 500 nm) = | | | | |
| 50:50 | | | | |
| Comparative | Slurry preparation | failure | failure | failure |
| Example 9 | was unsuccessful, | to test | to test | to test |
| 100% nano- | and the slurry could | | | |
| sized MnO₂ | not be stretched to | | | |
| (average | form a film and has | | | |
| particle size: | poor processability | | | |
| 500 nm) | | | | |

By comparing the examples with the comparative examples of the present disclosure, it can be determined from the described experimental results that the described examples of the present disclosure achieve the following technical effects.

Compared with Comparative Examples 3, 6 and 9 only containing nano-sized manganese dioxide particles, examples 1-9 of the present disclosure using a mixture of micron-sized manganese dioxide particles and nano-sized manganese dioxide particles having a specific range of average particle size improve the peeling strength (processing performance) and electrochemical properties of the MnO₂ positive electrode sheet with aqueous binder, and further reduce the costs and environmental load of the positive electrode.

Compared with Comparative Examples 1, 4 and 7 containing only micron-sized manganese dioxide particles, examples 1-9 of the present disclosure improve the electrochemical properties of the MnO₂ positive electrode sheet with aqueous binder; although examples 1-9 slightly reduce the peeling strength, the peeling strength achieved by examples 1-9 is still within an acceptable and preferable range in the art.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A manganese dioxide positive electrode material for a zinc ion battery, the manganese dioxide positive electrode material comprising:
a mixed material of micron-sized manganese dioxide particles and nano-sized manganese dioxide particles;
an aqueous binder; and
a conductive agent;
wherein the micron-sized manganese dioxide particles have an average particle size of about 1 μm to about 10 μm, and the nano-sized manganese dioxide particles have an average particle size of about 100 nm to about 500 nm.

2. The manganese dioxide positive electrode material of claim 1, wherein a weight ratio of the micron-sized manganese dioxide particles to the nano-sized manganese dioxide particles is 99:1 to 60:40.

3. The manganese dioxide positive electrode material of claim 1, wherein the aqueous binder is selected from the group consisting of polyacrylonitriles, styrene butadiene rubbers, polyacrylic acids, and any combination thereof.

4. The manganese dioxide positive electrode material of claim 1, wherein the micron-sized manganese dioxide particles have an average particle size of about 1 μm to about 5 μm, and the nano-sized manganese dioxide particles have an average particle size of about 100 nm to about 200 nm.

5. The manganese dioxide positive electrode material of claim 1, wherein a weight ratio of the micron-sized manganese dioxide particles to the nano-sized manganese dioxide particles is 80:20 to 60:40.

6. A method for preparing the manganese dioxide positive electrode sheet for a zinc ion battery, the method comprising:
mixing micron-sized manganese dioxide particles, nano-sized manganese dioxide particles, an aqueous binder, and a conductive agent to form a manganese dioxide positive electrode material;
adding water to the manganese dioxide positive electrode material to form a manganese dioxide positive electrode slurry; and
coating the manganese dioxide positive electrode slurry on a current collector to form a manganese dioxide positive electrode sheet;
wherein the micron-sized manganese dioxide particles have an average particle size of about 1 μm to about 10 μm, and the nano-sized manganese dioxide particles have an average particle size of about 100 nm to about 500 nm.

7. The method of claim 6, wherein the weight ratio of the micron-sized manganese dioxide particles to the nano-sized manganese dioxide particles is 99:1 to 60:40.

8. The method of claim 6, wherein the aqueous binder is selected from the group consisting of polyacrylonitriles, styrene butadiene rubbers, polyacrylic acids, and any combination thereof.

9. The method of claim 6, wherein the micron-sized manganese dioxide particles have an average particle size of about 1 μm to about 5 μm, and the nano-sized manganese dioxide particles have an average particle size of about 100 nm to about 200 nm.

10. The method of claim 6, wherein a weight ratio of the micron-sized manganese dioxide particles to the nano-sized manganese dioxide particles is 80:20 to 60:40.

11. A zinc ion battery, comprising:
a positive electrode sheet;
a negative electrode sheet, and
a separator,
wherein the positive electrode sheet comprises the manganese dioxide positive electrode material of claim 1.
